(19) United States
(12) Patent Application Publication
(10) Pub. No.: US 2008/0215781 A1
(43) Pub. Date: Sep. 4, 2008

(54) SYSTEM INCLUDING BUS MATRIX

(76) Inventors: Jae-Shin Lee, Seoul (KR); Cheon-Su Lee, Seoul (KR); Jin-Kwon Park, Suwon-si (KR)

Correspondence Address: F. CHAU & ASSOCIATES, LLC, 130 WOODBURY ROAD, WOODBURY, NY, 11797, US

(21) Appl. No.: 12/025,479

(22) Filed: Feb. 4, 2008

(30) Foreign Application Priority Data
Feb. 13, 2007 (KR) 10-2007-14971

(51) Int. Cl. G06F 13/18

(52) U.S. Cl. 710/110

(57) ABSTRACT

A system has a first chip using a first bus matrix, and a second chip including second and third bus matrixes connected to the first bus matrix. The second bus matrix is connected to a plurality of bus masters of the second chip and the third bus matrix is connected to a plurality of bus slaves of the second chip.

### CROSS-REFERENCE TO RELATED APPLICATIONS

This application claims priority under 35 U.S.C. § 119 to Korean Patent Application No. 10-2007-14971, filed on Feb. 13, 2007, the disclosure of which is incorporated by reference herein.

### BACKGROUND OF THE INVENTION

1. Technical Field

The present disclosure relates to semiconductor chips and more particularly, to a bus matrix structure in a semiconductor chip.

2. Discussion of Related Art

Advanced Extended Interface (AXI) interconnection of AMBA 3 is a conventional bus matrix configuration. An AXI interconnection is formed as a bus matrix with a plurality of channels. A plurality of bus masters and slaves are connected to the plurality of channels by multiplexers and demultiplexers. The bus masters are able to access different bus slaves at the same time by way of the AXI interconnection.

FIG. 1 is a block diagram of a conventional bus matrix. Referring to FIG. 1, bus masters 110˜140 operate to control generation of address and control signals during operation time of a system. Bus slaves 210˜250 operate in response to the control signals provided from the bus masters 110˜140.

The bus masters 110˜140 may include intelligent properties (IDs) such as a central processing unit (CPU), a direct memory access (DMA), a 3-dimensional graphic accelerator, etc. The bus slaves 210˜250 may include a memory controller, a special function register (SFR), etc.

In a conventional system bus, a single bus line is connected to a plurality of bus masters and slaves. While a current one of the bus masters is accessing one of the bus slaves, the rest of the bus masters are standing by until the current bus master terminates its use of the system bus.

The bus masters 110˜140 include a first bus master 110, a second bus master 120, a third bus master 130, and a fourth bus master 140. The bus slaves 210˜250 include a first bus slave 210, a second bus slave 220, a third bus slave 230, a fourth bus slave 240, and a fifth bus slave 250.

A bus matrix 300 includes a plurality of slave interfaces 311˜314 coupled to the bus masters 110˜140 and a plurality of master interfaces 321˜325 coupled to the bus slaves 210˜250. The slave interfaces 311˜314 include a first slave interface 311, a second slave interface 312, a third slave interface 313, and a fourth slave interface 314.

The master interfaces 321˜325 include a first master interface 321, a second master interface 322, a third master interface 323, a fourth master interface 324, and a fifth master interface 325

The first bus master 110 accesses the first bus slave 210 through the bus matrix 300, while the second bus master 120 accesses the second bus slave 220 through the bus matrix 300.

FIG. 2 is a block diagram showing ID widths of the master interfaces in the bus matrix shown in FIG. 1. Referring to FIG. 2, the bus matrix 300 includes first and second slave interfaces 311 and 312, and a first master interface 321. The first bus master 110, a second bus master 120, and a first bus slave 210 are connected to the bus matrix 300.

An ID width of a master interface M_{id}_{_{—}}_{width} is calculated using the following Equation 1:

M_{id}_{_{—}}_{width}=S_{id}_{_{—}}_{width}+log₂(N_{S}_{_{—}}_{1/F}) [Equation 1]

where S_{id}_{_{—}}_{width} represents the largest bit in corresponding slave interfaces and N_{S}_{_{—}}_{1/F} represents the number of the slave interfaces.

The ID width of the first master interface 321 includes a sum of the largest ID width of the slave interfaces 311 and 312, and a bit for selecting one of the slave interfaces 311 and 312 by the first master interface 321.

Assuming that ID widths of the first and second slave interfaces 311 and 312 are 2 and 4 bits respectively, the ID width of the first master interface 321 is set to 5 bits by Equation 1.

It is assumed that the system is organized with a first chip including a first bus matrix and a second chip including a second bus matrix connected to the first bus matrix.

An ID width of the master interface in the first bus matrix is determined by the slave interfaces of the second bus matrix. An ID width of the master interface in the second bus matrix is determined by the slave interfaces of the first bus matrix.

If the first master interface of the first bus matrix is connected to the first slave interface of the second bus matrix, the first slave interface of the second bus matrix affects the ID width of the first master interface of the second bus matrix.

If the first master interface of the second bus matrix is connected to the second slave interface of the first bus matrix, the second slave interface of the first bus matrix affects the ID width of the first master interface of the first bus matrix.

As a result, the ID widths of the first master interfaces may be irregular. Thus, there is a need for a bus matrix structure for determining ID widths of master interfaces of first and second bus matrixes in a semiconductor chip system.

### SUMMARY OF THE INVENTION

An exemplary embodiment of the present invention is a system including a first chip and a second chip. The first chip includes a first bus matrix. The second chip includes second and third bus matrixes connected to the first bus matrix. The second bus matrix is connected to a plurality of bus masters of the second chip and the third bus matrix is connected to a plurality of bus slaves of the second chip.

The first bus matrix may include a plurality of master and slave interfaces. In the first bus matrix, one of the slave interfaces may be connected to one of the bus masters. In the first bus matrix, one of the master interfaces may be connected to one of the bus slaves. In the first bus matrix, an ID width of one of the master interfaces may correspond to a sum of the largest ID width of the plurality of slave interfaces and the smallest bit count required for uniquely selecting one of the plurality of slave interfaces.

The second bus matrix may include a plurality of master and slave interfaces. In the second bus matrix, one of the slave interfaces may be connected to one of the plurality of bus masters. In the second bus matrix, one of the master interfaces may be connected to one of the plurality of bus slaves. In the second bus matrix, an ID width of one of the master interfaces may correspond to a sum of the largest ID width of the plurality of slave interfaces and the smallest bit count required for uniquely selecting one of the plurality of slave interfaces.

The third bus matrix may include a plurality of master and slave interfaces. In the third bus matrix, one of the slave interfaces may connect to one of the plurality of bus masters. In the third bus matrix, one of the master interfaces may connect to one of the plurality of bus slaves. In the third bus matrix, an ID width of one of the master interfaces may correspond to a sum of the largest ID width of the plural slave interfaces and the smallest bit count required for uniquely selecting one of the plurality of slave interfaces.

The first chip may include an intelligent property provided by a foundry. The intelligent property provided by the foundry may be one of a processor, a direct memory access, and a memory controller. The second chip may comprise an intelligent property developed by a customer.

### BRIEF DESCRIPTION OF THE DRAWINGS

The present invention will become readily apparent by reference to the following figures, wherein:

FIG. 1 is a block diagram of a conventional bus matrix;

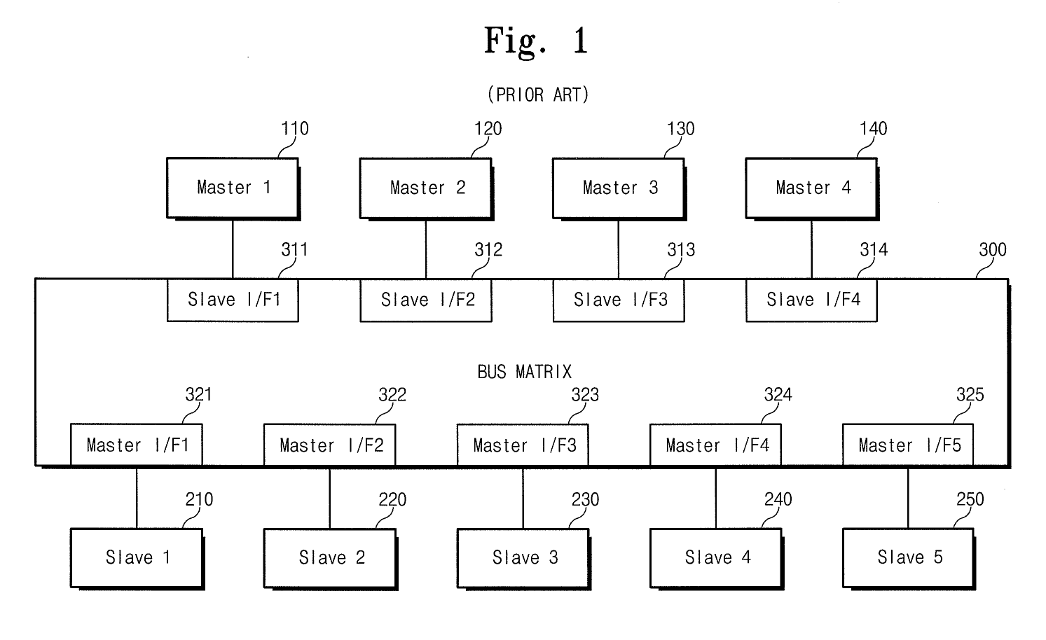

FIG. 2 is a block diagram showing ID widths of the master interfaces in the bus matrix shown in FIG. 1;

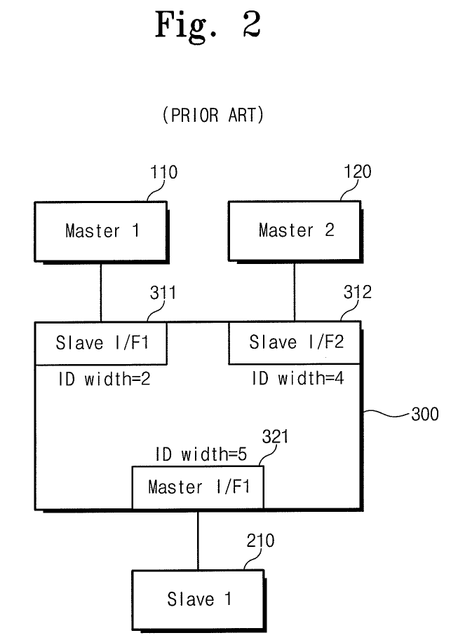

FIG. 3 is a block diagram illustrating a first chip including a first bus matrix and a second chip including a second bus matrix connected to the first bus matrix;

FIG. 4 is a block diagram of a bus matrix according to an exemplary embodiment of the present invention; and

FIG. 5 is a block diagram showing ID widths of the first and second chips shown in FIG. 4.

### DETAILED DESCRIPTION OF EXEMPLARY EMBODIMENTS

Hereinafter exemplary embodiments of the present invention will be described below in more detail with reference to the accompanying drawings. Like reference numerals refer to like elements throughout the accompanying figures.

System-on-chips (SOCs) implemented in single chips may be fabricated by two divisional chips for ease of development. For example, a first chip, referred to as a base chip, may include intelligent properties (IPs), such as an ARM core, DMA, and/or a memory controller, and a second chip, referred to as a companion chip, may include IPs developed directly by customers or necessary for chip functions.

Since existing customers are already familiar with developing and verifying the functional performance of IPs of SOCs having a first chip, it should not be overly burdensome for them to manage a second chip.

An SOC having two divisional chips is employable in application-specific integrated circuits (ASICs) or application-specific standard products (ASSPs) when a first one of the chips is provided by a foundry which embeds general IPs therein.

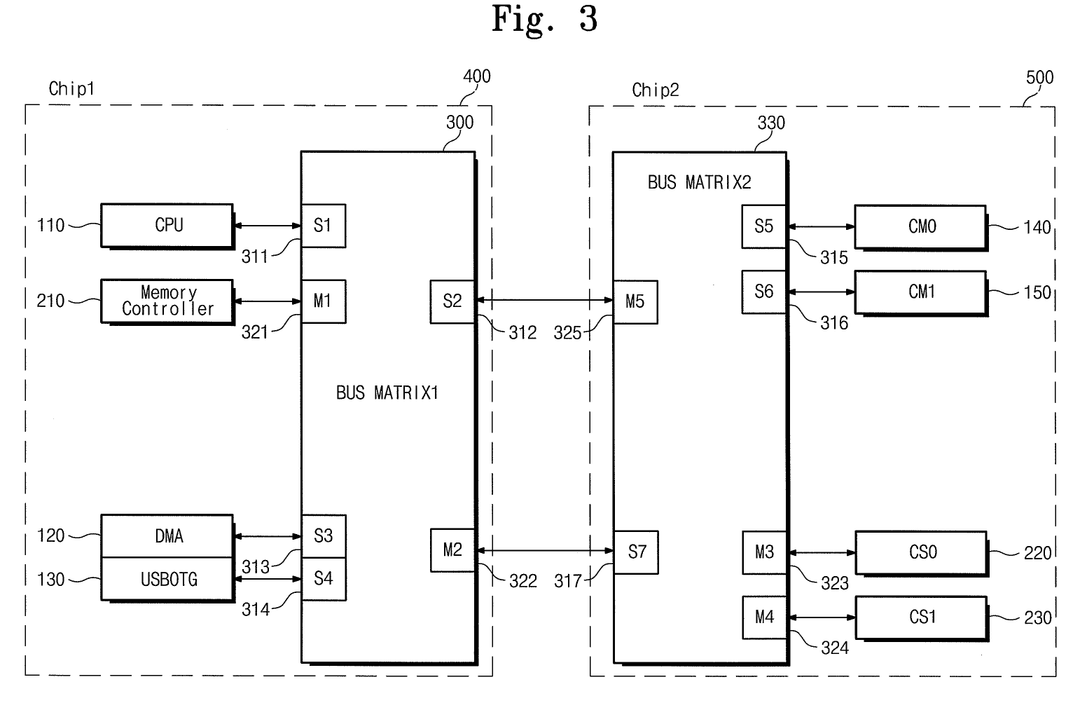

FIG. 3 is a block diagram illustrating the first chip including a first bus matrix and the second chip including a second bus matrix connected to the first bus matrix. Referring to FIG. 3, the first chip 400 includes a CPU 110, a memory controller 210, a DMA 120, a universal serial bus on-the-go (USBOTG) 130, and a first bus matrix 300.

The first bus matrix 300 includes a plurality of slave interfaces 311˜314 and a plurality of master interfaces 321 and 322. The slave interfaces 311˜314 include the first slave interface 311, the second slave interface 312, the third slave interface 313, and the fourth slave interface 314. The master interfaces 321 and 322 include the first master interface 321 and the second master interface 322.

Bus masters 110˜130 are connected to the slave interfaces 311, 313, and 314 and the bus slave 210 is connected to the master interface 321. The CPU 110 is connected to the first slave interface 311 and the DMA 120 is connected to the third slave interface 313. The USBOTG 130 is connected to the fourth slave interface 314. The memory controller 210 is connected to the first master interface 321.

The second slave interface 312 of the first bus matrix 300 is connected to a fifth master interface 325 of the second bus matrix 330, and the second master interface 322 of the first bus matrix 300 is connected to a seventh slave interface 317 of the second bus matrix 330.

The second chip 500 includes a first customer master (CM0) 140, a second customer master (CM1) 150, a first customer slave (CS0) 220, a second customer slave (CS1) 230, and the second bus matrix 330.

The second bus matrix 330 includes a plurality of slave interfaces 315˜317 and a plurality of master interfaces 323˜325. The slave interfaces 315˜317 include the fifth slave interface 315, the sixth slave interface 316, and the seventh slave interface 317. The master interfaces 323˜325 include the fifth master interface 325, the sixth master interface 326, and the seventh master interface 327.

The CM0 140 and CM1 150 correspond each to first and second bus masters developed or required by a customer. The CS0 220 and CS1 230 correspond each to first and second slaves controlled by one of the bus masters of the first or second chip.

The CM0 140 is connected to the fifth slave interface 315 and the CM1 150 is connected to the sixth slave interface 316. The CS0 220 is connected to the third master interface 323 and the CS1 230 is connected to the fourth master interface 324.

The fifth master interface 325 is connected to the second slave interface 312 of the first bus matrix 300 and the seventh slave interface 317 is connected to the second master interface 322 of the first bus matrix 300.

The CPU 110 transfers commands and control signals to the bus slaves 210˜230 by way of the first bus matrix 300 or the second bus matrix 330 connected to the first bus matrix 300. The DMA 120 transfers data to an external system by way of the first bus matrix 300 or a third bus matrix connected to the first bus matrix 300 without intervention of the CPU 110. The USBOTG 130 is a bus master for directly controlling an external device through an USB interface. The CM0 140 or the CM1 150 is an IP developed or required by a customer. The CM0 140 or the CM1 150 operates to control the CS0 220 or the CS1 230, or control an external memory by way of the memory controller 210.

The CPU 110 accesses the memory controller 210 through the first bus matrix 300. At the same time, the DMA 120 accesses the CS0 220 or the CS1 230 through the third bus matrix connected to the first bus matrix 300.

The CM0 140 accesses the CS0 220 or the CS1 230 by way of the third bus matrix connected to the second bus matrix 330. At the same time, the CM1 150 accesses the memory controller 210 by way of the first bus matrix 300 connected to the second bus matrix 330.

An ID width of the second master interface 322 of the first bus matrix 300 is determined by the seventh slave interface 317 of the second bus matrix 330. An ID width of the fifth master interface 325 of the second bus matrix 330 is determined by the second slave interface 312 of the first bus matrix 300.

The second slave interface 312 has a same ID width as the fifth master interface 325. The seventh slave interface 317 has a same ID width as the second master interface 322. Since the second and fifth interfaces, 322 and 325, affect each other by ID width, it is difficult to have regular ID widths thereof.

An exemplary embodiment of the present invention provides a new structure for the bus matrix 330 of the second chip 500. The bus matrix 330 of the second chip 500 is divided into two structures, a first structure for connecting the bus masters with each other, and a second structure for connecting the bus slaves with each other.

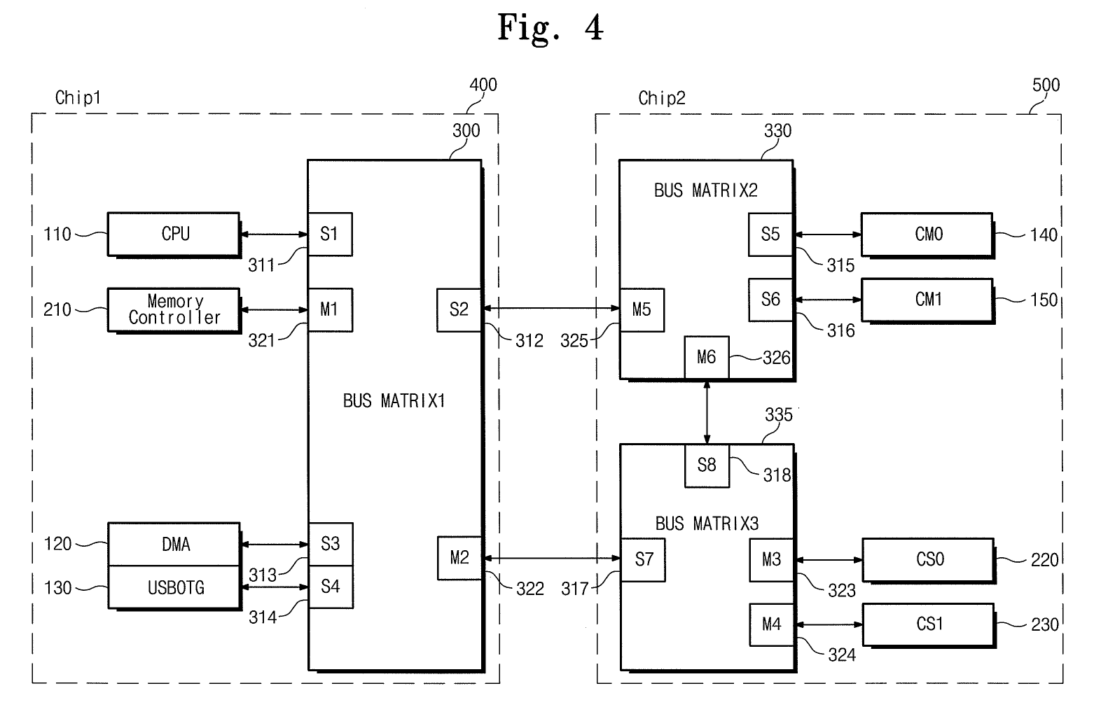

FIG. 4 is a block diagram of a bus matrix according to an exemplary embodiment of the present invention. The first chip 400 of FIG. 4 is similar to the first chip 400 of FIG. 3. Referring to FIG. 4, the second chip 500 includes the first customer master (CM0) 140, the second customer master (CM1) 150, the first customer slave (CS0) 220, the second customer slave (CS1) 230, the second bus matrix 330, and the third bus matrix 335.

The second bus matrix 330 includes the slave interfaces 315 and 316 and the master interfaces 325 and 326. The slave interfaces include the fifth and sixth slave interfaces 315 and 316. The master interfaces include the fifth and sixth master interfaces 325 and 326.

The CM0 140 is connected to the fifth slave interface 315 and the CM1 150 is connected to the sixth slave interface 316. The fifth master interface 325 is connected to the second slave interface 312 of the first bus matrix 300 and the sixth master interface 326 is connected to the eighth slave interface 318 of the third bus matrix 335.

The third bus matrix 335 includes slave interfaces 317 and 318 and master interfaces 323 and 324. The slave interfaces include the seventh slave interface 317 and the eight slave interface 318. The master interfaces include the third master interface 323 and the fourth master interface 324.

The CS0 220 is connected to the third master interface 323 and the CS1 230 is connected to the fourth master interface 324. The seventh slave interface 317 is connected to the second master interface 322 of the first bus matrix 300. The eighth slave interface 318 is connected to the sixth master interface 326 of the second bus matrix 330.

The bus masters 140 and 150 of the second chip 500 are connected to the second bus matrix 330. The bus slaves 220 and 230 of the second chip 500 are connected to the third bus matrix 335. Data streams of the bus matrixes formed in the first and second chips are unilaterally controlled to determine an ID width of the master interface of each bus matrix by means of Equation 1.

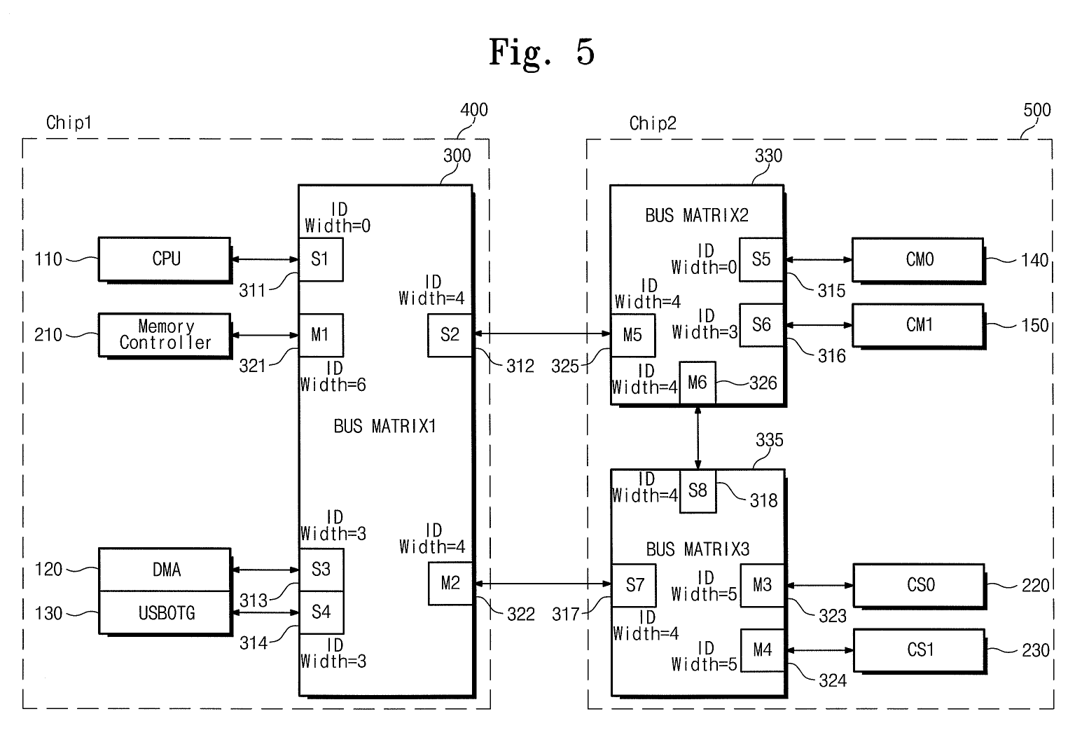

FIG. 5 is a block diagram showing a feature of determining ID widths of the first and second chips shown in FIG. 4, according to an exemplary embodiment of the present invention. Referring to FIG. 5, it is assumed that: an ID width of the first slave interface 311 is 0 bits; an ID width of the second slave interface 312 is 4 bits; an ID width of the third slave interface 313 is 3 bits; an ID width of the fourth slave interface 314 is 3 bits; an ID width of the fifth slave interface 315 is 0 bits; an ID width of the sixth slave interface 316 is 3 bits; an ID width of the seventh slave interface 317 is 4 bits; and an ID width of the eight slave interface 314 is 4 bits.

The ID width of the first master interface 321 can be given by summing the largest ID width for a slave interface and log₂ [the total number of the slave interfaces] by Equation 1. For example, referring to bus matrix 300, since the largest ID width for a slave interface is 4 bits (i.e., ID width of second slave interface 312) and there are four slave interfaces (i.e., slave interfaces 311˜314), the ID width of the first master interface 321 is 6 bits (i.e., 4+log₂4=6). The log₂ [the total number of the slave interfaces] may correspond to the smallest bit count required for uniquely selecting one of the slave interfaces. For example, four slave interfaces may be uniquely selected by 2 (e.g., log₂4=2) bits.

An ID width of the second master interface 322 is identical to that of the seventh slave interface 317. An ID width of the fifth master interface 325 is identical to that of the second slave interface 312. An ID width of the sixth master interface 326 is identical to that of the eighth slave interface 318. The ID width of the second master interface 322 is 4 bits and the ID width of the fifth master interface 325 is 4 bits. The ID width of the sixth master interface 326 is 4 bits.

ID widths of the third and fourth master interfaces 323 and 324 are obtained from Equation 1 in a similar manner as the first master interface 321 above. For example, referring to bus matrix 335, since the largest ID width for a slave interface is 4 bits (i.e., ID width of seventh slave interface 317 or eighth slave interface 318) and there are two slave interfaces (i.e., slave interfaces 317 and 318), the ID width of the third and fourth master interfaces 323 and 324 is 5 bits (i.e., 4+log₂2=5).

Further, an ID width of the master interface may be formed by a combination of a bit involved in a master interface among the slave interfaces and a bit for selecting one of the slave interfaces.

The structure shown in FIG. 5 (e.g., the first chip 400 having the first bus matrix 300, the second chip 500 having the second bus matrix 330 connected to the slave interface 312 of the first bus matrix 300, and the third bus matrix 335 connected to the master interface 322 of the first bus matrix 300) may determine ID widths of the master interfaces of the first, second, and third bus matrixes 300, 330, and 335.

While the present invention has been particularly shown and described with reference to exemplary embodiments thereof, it is to be understood that the present invention is not limited to these exemplary embodiments, but various changes and modifications can be made by one ordinary skilled in the art within the spirit and scope of the present invention.

What is claimed is:

1. A system comprising:
a first chip using a first bus matrix; and
a second chip including second and third bus matrixes connected to the first bus matrix,
wherein the second bus matrix is connected to a plurality of bus masters of the second chip and the third bus matrix is connected to a plurality of bus slaves of the second chip.

2. The system as set forth in claim 1, wherein the first bus matrix comprises a plurality of master and slave interfaces.

3. The system as set forth in claim 2, wherein one of the slave interfaces is connected to one of the bus masters.

4. The system as set forth in claim 2, wherein one of the master interfaces is connected to one of the bus slaves.

5. The system as set forth in claim 4, wherein an ID width of one of the master interfaces corresponds to a combination of the largest ID width of the plurality of slave interfaces and the smallest bit count required for uniquely selecting one of the plurality of slave interfaces.

6. The system as set forth in claim 4, wherein an ID width of one of the master interfaces corresponds to a combination of a bit involved in the master interface among the plurality of slave interfaces and a bit for selecting one of the plurality of slave interfaces.

7. The system as set forth in claim 1, wherein the second bus matrix comprises a plurality of master and slave interfaces.

8. The system as set forth in claim 7, wherein one of the slave interfaces is connected to one of the bus masters.

9. The system as set forth in claim 7, wherein one of the master interfaces is connected to one of the bus slaves.

10. The system as set forth in claim 9, wherein an ID width of one of the master interfaces corresponds to a sum of the largest ID width of the plurality of slave interfaces and the smallest bit count required for uniquely selecting one of the plurality of slave interfaces.

11. The system as set forth in claim 9, wherein an ID width of the master interface corresponds to a combination of a bit involved in one of the master interfaces among the plurality of slave interfaces and a bit for selecting one of the plurality of slave interfaces.

12. The system as set forth in claim 1, wherein the third bus matrix comprises a plurality of master and slave interfaces.

13. The system as set forth in claim 12, wherein one of the slave interfaces is connected to one of the bus masters.

14. The system as set forth in claim 12, wherein one of the master interfaces is connected to one of the bus slaves.

15. The system as set forth in claim 14, wherein an ID width of one of the master interfaces corresponds to a sum of the largest ID width of the plurality of slave interfaces and the smallest bit count required for uniquely selecting one of the plurality of slave interfaces.

16. The system as set forth in claim 1, wherein the first chip comprises an intelligent property provided by a foundry.

17. The system as set forth in claim 16, wherein the intelligent property provided by the foundry is one of a processor, a direct memory access, and a memory controller.

18. The system as set forth in claim 17, wherein the second chip comprises an intelligent property requested from the foundry.

19. The system as set forth in claim 1, wherein the second chip comprises an intelligent property developed by a customer.
